(19) United States
(12) Patent Application Publication
(10) Pub. No.: US 2017/0036863 A1
(43) Pub. Date: Feb. 9, 2017

(54) CONTOURED CONVEYOR COVER

(71) Applicant: Formax, Inc., Mokena, IL (US)

(72) Inventor: Kyle Schinkowsky, Genoa City, WI (US)

(21) Appl. No.: 14/817,255

(22) Filed: Aug. 4, 2015

(51) Int. Cl. B65G 33/14; B65G 33/24

(52) U.S. Cl. CPC B65G 33/14; B65G 33/24

(57) ABSTRACT

A conveyor includes a housing, a moveable conveyor member, and a cover. The housing includes a trough. The moveable conveyor member is disposed within the trough. The cover is moveably attached to the housing between a closed position covering the trough and an open position uncovering the trough. The cover includes an inner surface having a curvature matching the curvature of an outer surface of the moveable conveyor member.

### FIELD OF THE DISCLOSURE

This disclosure relates to contoured covers for conveyors.

### BACKGROUND

Covers are used by some of the current conveyors, such as screw conveyors or other types of conveyors, in order to gain access to the internal components of the conveyor. However, product carried by these conveyors may sometimes tumble or roll-over within the conveyor between the cover and the moving conveyor resulting in inefficiencies in conveying the product with the conveyor. Moreover, the current conveyors may experience one or more additional issues.

A conveyor cover is needed to reduce one or more issues of one or more of the current conveyors and their corresponding methods of use.

### SUMMARY

In one embodiment, a screw conveyor is disclosed. The screw conveyor includes a housing, a rotate-able helical screw blade, and a cover. The housing includes a trough. The rotate-able helical screw blade is disposed within the trough. The cover is moveably attached to the housing between a closed position covering the trough and an open position uncovering the trough. The cover includes an inner surface having a curvature matching the curvature of an outer surface of the rotate-able helical screw blade.

In another embodiment, a conveyor is disclosed. The conveyor includes a housing, a moveable conveyor member, and a cover. The housing includes a trough. The moveable conveyor member is disposed within the trough. The cover is moveably attached to the housing between a closed position covering the trough and an open position uncovering the trough. The cover includes an inner surface having a curvature matching the curvature of an outer surface of the moveable conveyor member.

In still another embodiment, a method of attaching a cover to a conveyor is disclosed. In one step, a moveable conveyor member is disposed within a trough of a housing. In another step, a cover is attached to the housing so that the cover is moveable between a closed position covering the trough and an open position uncovering the trough. The cover includes an inner surface having a curvature matching the curvature of an outer surface of the moveable conveyor member.

In yet another embodiment, a method of moving a product within a conveyor is disclosed. In one step, a cover is closed to cover a trough of a housing. In another step, a conveyor member is moved within the trough of the housing to move a product, carried by the conveyor member, through the trough of the housing with an inner surface of the cover reducing tumbling or rolling-over of the product due to a curvature of the inner surface of the cover matching the curvature of an outer surface of the conveyor member.

The scope of the present disclosure is defined solely by the appended claims and is not affected by the statements within this summary.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 illustrates a perspective view of one embodiment of a conveyor;

FIG. 2 illustrates an end view of the conveyor of the embodiment of FIG. 1;

FIG. 3 illustrates a flowchart of one embodiment of a method of attaching a cover to a conveyor; and

FIG. 4 illustrates a flowchart of one embodiment of a method of moving a product with a conveyor.

### DETAILED DESCRIPTION

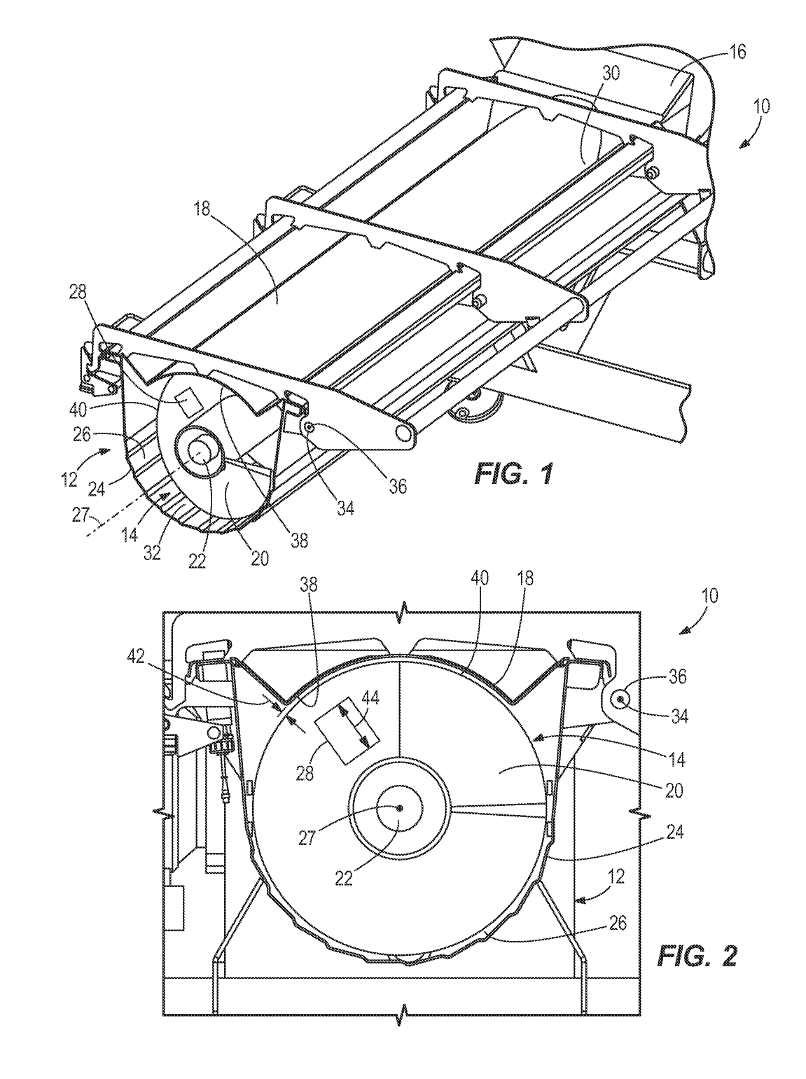

FIG. 1 illustrates a perspective view of one embodiment of a conveyor 10. FIG. 2 illustrates an end view of the conveyor 10 of the embodiment of FIG. 1. As illustrated collectively in FIGS. 1 and 2, the conveyor 10 comprises a housing 12, a moveable conveyor member 14, a motor 16, and a cover 18. The conveyor 10 comprises a screw conveyor with the moveable conveyor member 14 comprising a rotate-able, helical screw blade 20 attached to a shaft 22. In other embodiments, the conveyor 10 and the moveable conveyor member 14 may comprise any type of conveyor and/or moveable conveyor member.

The housing 12 comprises an outer surface 24 defining a trough 26. The outer surface 24 is semi-circular. In other embodiments, the shape, size, configuration, and orientation of the housing 12 may vary. The moveable conveyor member 14 is disposed in the trough 26. The motor 16 rotates the shaft 22 around axis 27 thereby rotating the attached helical screw blade 20 around the axis 27 to move product 28, carried by the helical screw blade 20, from an input location 30 at the bottom of the conveyor 10 to an output location 32 at the top of the conveyor 10. The product 28 may comprise any type of product such as a food product or another type of non-food product which needs to be moved from one location to another using the conveyor 10.

The cover 18 is moveably attached to the housing 12 between a closed position covering the trough 26 and an open position uncovering the trough 26. The cover 18 is rotate-ably attached to the housing 12 with a hinge 34 at a pivot point 36 rotate-ably attaching the cover 18 to the housing 12 so that the cover 18 is moveable between the closed position covering the trough 26 and the open position uncovering the trough 26. When the cover 18 is disposed in the open position uncovering the trough 26, the moveable conveyor member 14 disposed within the trough 26 is exposed allowing for a user to gain access to the moveable conveyor member 14 for maintenance.

The cover 18 comprises an inner surface 38 having a curvature matching the curvature of an outer surface 40 of the moveable conveyor member 14. The outer surface 40 of the moveable conveyor member 14 is disposed farther away from the axis 27 than any other surface of the moveable conveyor member 14. The cover 18, including the inner surface 38 of the cover 18, is semi-circular. In other embodiments, the curvature/shape of the inner surface 38 of the cover 18 and of the outer surface 40 of the moveable conveyor member 14 may vary. The outer surface 40 of the moveable conveyor member 14 is disposed adjacent to the inner surface 38 of the cover 18. All portions of the inner surface 38 of the cover 18 are disposed equidistant from the outer surface 40 of the moveable conveyor member 14. The outer surface 40 of the moveable conveyor member 14 may be disposed in a range of 1/32 inches to 2 inches away from the inner surface 38 of the cover 18. In other embodiments, the outer surface 40 of the moveable conveyor member 14 may be disposed at varying distances away from the inner surface 38 of the cover 18. The resulting gap 42, formed between the outer surface 40 of the moveable conveyor member 14 and the inner surface 38 of the cover 18, is smaller than the largest dimension 44 of the product 28.

The curvature of the inner surface 38 of the cover 18 matching the curvature of the outer surface 40 of the moveable conveyor member 14 allows for the gap 42 to be uniformly smaller, along the entire inner surface 38 of the cover 18, than the largest dimension 44 of the product 28. This prevents or reduces tumbling or rolling-over of the product 28 as the moveable conveyor member 14 moves the product 28 from the input location 30 at the bottom of the conveyor 10 to the output location 32 at the top of the conveyor 10 due to the cover's shape keeping the product 28 closer to the moveable conveyor member 14. This results in increases in the drivability and efficiency of the product 10 moving along the axis 27 of the conveyor 10 as the less the product 28 rolls-over or tumbles the more the product 28 will translate along the axis 27 of the conveyor 10.

In other embodiments, the conveyor 10, housing 12, moveable conveyor member 14, motor 16, and cover 18 may vary in type, shape, configuration, orientation, configuration, or function.

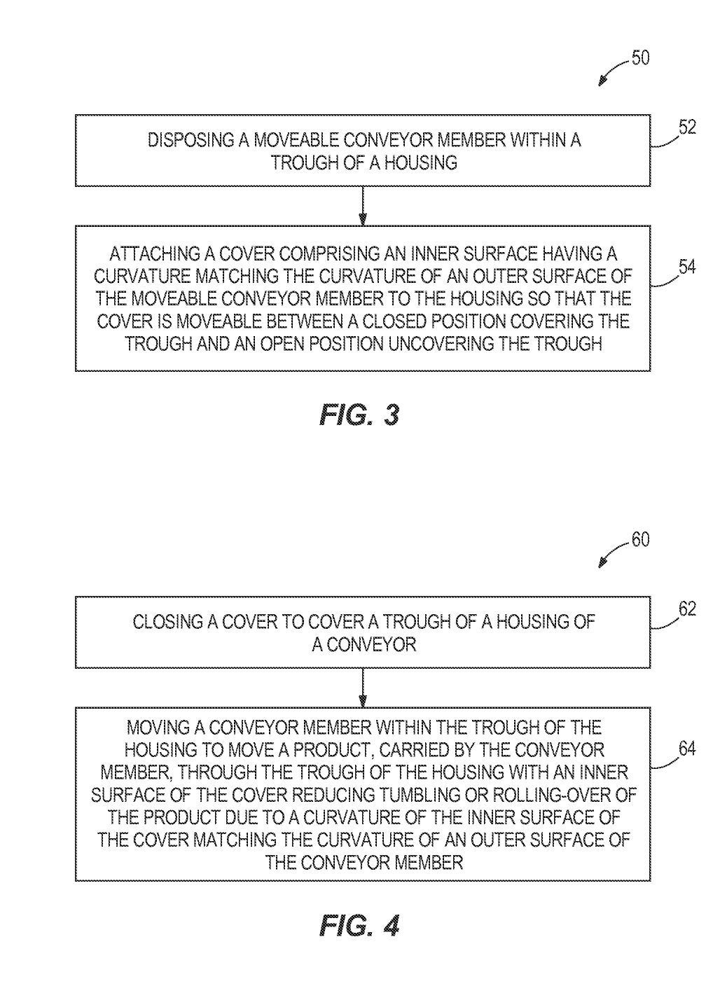

FIG. 3 illustrates a flowchart of one embodiment of a method 50 of attaching a cover to a conveyor. The method 50 may utilize any conveyors of the instant disclosure. In other embodiments, the method 50 may utilize varying conveyors. In step 52, a moveable conveyor member is disposed within a trough of the housing. In one embodiment, the moveable conveyor member may comprise a rotate-able helical screw blade. In other embodiments, the moveable conveyor member may vary. In one embodiment, step 52 may comprise rotateably disposing the moveable conveyor member around an axis so that an outer surface of the moveable conveyor member is farther away from the axis than any other surface of the moveable conveyor member. In step 54, a cover comprising an inner surface having a curvature matching the curvature of an outer surface of the moveable conveyor member is attached to the housing so that the cover is moveable between a closed position covering the trough and an open position uncovering the trough.

In one embodiment, the cover is semi-circular. In other embodiments, the shape, size, orientation, configuration, and location of the cover may vary. In one embodiment, step 54 comprises disposing all portions of the inner surface of the cover equidistant from the outer surface of the moveable conveyor member. In one embodiment, step 54 comprises disposing the inner surface of the cover adjacent to the outer surface of the moveable conveyor member. In one embodiment, step 54 comprises disposing the inner surface of the cover so that the outer surface of the moveable conveyor member is in a range of 1/32 inches to 2 inches away from the inner surface of the cover. In other embodiments, step 54 comprises disposing the inner surface of the cover so that the outer surface of the moveable conveyor member is disposed at varying distances away from the inner surface of the cover. In one embodiment, step 54 comprises rotate-ably attaching the cover to the housing with a hinge located at a pivot point so that the cover is rotate-able between the closed position covering the trough and the open position uncovering the trough.

In other embodiments, one or more steps of the method 50 may be varied in substance or order, one or more steps of the method 50 may not be followed, or one or more additional steps may be added to the method 50. In still other embodiments, the method 50 may vary further.

FIG. 4 illustrates a flowchart of one embodiment of a method 60 of moving a product with a conveyor. The method 60 may utilize any conveyors of the instant disclosure. In other embodiments, the method 60 may utilize varying conveyors. In step 62, a cover is closed to cover a trough of a housing of a conveyor. The cover may be semi-circular. In other embodiments, the cover may vary in shape, size, orientation, or configuration. In step 64, a conveyor member is moved within the trough of the housing to move a product, carried by the conveyor member, through the trough of the housing with an inner surface of the cover reducing tumbling or rolling-over of the product due to a curvature of the inner surface of the cover matching the curvature of an outer surface of the conveyor member. The product carried by the conveyor member may comprise any type of food or non-food product.

In one embodiment, step 62 comprises disposing the inner surface of the cover to be adjacent to the outer surface of the moveable conveyor member. In one embodiment, step 62 comprises disposing all portions of the inner surface of the cover equidistant from the outer surface of the moveable conveyor member. In one embodiment, step 62 comprises disposing the inner surface of the cover to be in a range of 1/32 inches to 2 inches away from the outer surface of the moveable conveyor member. In other embodiments, step 62 comprises disposing the inner surface of the cover at varying distances away from the outer surface of the moveable conveyor member. In one embodiment, step 62 comprises disposing the inner surface of the cover to form a continuous, uniform gap between the inner surface of the cover and an outer surface of the moveable conveyor member, with a width of the uniform gap being smaller than a largest dimension of the product being carried by the moveable conveyor member. In one embodiment, step 62 comprises rotating the cover relative to the housing with a hinge located at the pivot point so that the cover rotates from an open position uncovering the trough to the closed position covering the trough.

In one embodiment, step 64 comprises rotating a helical screw blade within the trough. In other embodiments, step 64 may comprise moving varying types of conveyor members through the trough. In one embodiment, step 64 comprises rotating the moveable conveyor member around an axis so that the outer surface is farther away from the axis than any other surface of the moveable conveyor member.

In other embodiments, one or more steps of the method 60 may be varied in substance or order, one or more steps of the method 60 may not be followed, or one or more additional steps may be added to the method 60. In still other embodiments, the method 60 may vary further.

One or more embodiments of the disclosure, utilizing a contoured conveyor cover that wraps around the moveable conveyor member, may reduce tumbling and/or rolling over of product conveyed by the conveyor while at the same time allowing access to the internal components of the conveyor. This will result in improvement in the efficiency of the conveyor, due to the less the product rolling-over or tumbling the more the product translating along the axis of the conveyor, while also improving the conveyor's ability to convey product up steeper inclines. Moreover, one or more embodiments of the disclosure may reduce or eliminate one or more additional issues of one or more of the current conveyors.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. Furthermore, it is to be understood that the disclosure is defined by the appended claims. Accordingly, the disclosure is not to be restricted except in light of the appended claims and their equivalents.

1. A screw conveyor comprising:
a housing comprising a trough;
a rotate-able helical screw blade disposed within the trough;
an input location, for inputting product to be carried by the rotate-able helical screw blade, in the trough at a bottom of the screw conveyor;
an output location, for outputting the product carried by the rotate-able helical screw blade, in the trough at a top of the screw conveyor;
a cover moveably attached to the housing, the cover moveable between a closed position covering the trough and an open position uncovering the trough, the cover comprising an inner surface having a curvature matching the curvature of an outer surface of the rotate-able helical screw blade; and
a gap, disposed between the outer surface of the rotate-able helical screw blade and the inner surface of the cover, which is smaller than the product to reduce tumbling or rolling-over of the product between the outer surface of the rotate-able helical screw blade and the inner surface of the cover.

2. The screw conveyor of claim 1 wherein the outer surface of the rotate-able helical screw blade is disposed adjacent to the inner surface of the cover.

3. The screw conveyor of claim 1 wherein all portions of the inner surface of the cover are disposed equidistant from the outer surface of the rotate-able helical screw blade.

4. The screw conveyor of claim 1 wherein the outer surface of the rotate-able helical screw blade is disposed in a range of 1/32 inches to 2 inches away from the inner surface of the cover.

5. The screw conveyor of claim 1 wherein the cover is semi-circular.

6. The screw conveyor of claim 1 wherein the rotate-able helical screw blade rotates around an axis, the outer surface being farther away from the axis than any other surface of the rotate-able helical screw blade.

7. The screw conveyor of claim 1 wherein the cover is rotate-ably attached to the housing at a pivot point, the cover rotate-able between the closed position covering the trough and the open position uncovering the trough.

8. The screw conveyor of claim 7 wherein a hinge rotate-ably attaches the cover to the housing at the pivot point.

9. A conveyor comprising:
a housing comprising a trough;
a moveable conveyor member disposed within the trough;
an input location, for inputting product to be carried by the moveable conveyor member, in the trough at a bottom of the conveyor;
an output location, for outputting the product carried by the moveable conveyor member, in the trough at a top of the conveyor;
a cover moveably attached to the housing, the cover moveable between a closed position covering the trough and an open position uncovering the trough, the cover comprising an inner surface having a curvature matching the curvature of an outer surface of the moveable conveyor member; and
a gap, disposed between the outer surface of the moveable conveyor member and the inner surface of the cover, which is smaller than the product to reduce tumbling or rolling-over of the product between the outer surface of the moveable conveyor member and the inner surface of the cover.

10. The conveyor of claim 9 wherein the outer surface of the moveable conveyor member is disposed adjacent to the inner surface of the cover.

11. The conveyor of claim 9 wherein all portions of the inner surface of the cover are disposed equidistant from the outer surface of the moveable conveyor member.

12. The conveyor of claim 9 wherein the outer surface of the moveable conveyor member is disposed in a range of 1/32 inches to 2 inches away from the inner surface of the cover.

13. The conveyor of claim 9 wherein the cover is semi-circular.

14. The conveyor of claim 9 wherein the moveable conveyor member rotates around an axis, the outer surface being farther away from the axis than any other surface of the moveable conveyor member.

15. The conveyor of claim 9 wherein the cover is rotate-ably attached to the housing at a pivot point, the cover rotate-able between the closed position covering the trough and the open position uncovering the trough.

16. The conveyor of claim 15 wherein a hinge rotate-ably attaches the cover to the housing at the pivot point.

17. A method of attaching a cover to a conveyor comprising:
disposing a moveable conveyor member within a trough of a housing to form the conveyor so that product inputted into the conveyor will be carried by the moveable conveyor member from the input location of the trough at a bottom of the conveyor to an output location in the trough at a top of the conveyor; and
attaching a cover to the housing so that: the cover is moveable between a closed position covering the trough and an open position uncovering the trough, the cover comprising an inner surface having a curvature matching the curvature of an outer surface of the moveable conveyor member; and a gap is formed between the outer surface of the moveable conveyor member and the inner surface of the cover, the gap being smaller than the product to reduce tumbling or rolling-over of the product between the outer surface of the moveable conveyor member blade and the inner surface of the cover.

18. The method of claim 17 wherein the moveable conveyor member comprises a rotate-able helical screw blade.

19. The method of claim 17 wherein the attaching the cover to the housing comprises disposing all portions of the inner surface of the cover equidistant from the outer surface of the moveable conveyor member.

20. The method of claim 17 wherein the attaching the cover to the housing comprises disposing the inner surface of the cover to be adjacent to the outer surface of the moveable conveyor member.

21. The method of claim 17 wherein the attaching the cover to the housing comprises disposing the inner surface of the cover to be in a range of 1/32 inches to 2 inches away from the outer surface of the moveable conveyor member.

22. The method of claim 17 wherein the cover is semi-circular.

23. The method of claim 17 wherein the disposing the moveable conveyor member within the trough of the housing comprises rotate-ably disposing the moveable conveyor member around an axis so that the outer surface is farther away from the axis than any other surface of the moveable conveyor member.

24. The method of claim 17 wherein the attaching the cover to the housing comprises rotate-ably attaching the cover to the housing at a pivot point so that the cover is rotate-able between the closed position covering the trough and the open position uncovering the trough.

25. The method of claim 24 wherein the attaching the cover to the housing comprises rotate-ably attaching the cover to the housing with a hinge located at the pivot point.

26. A method of moving product with a conveyor comprising:
closing a cover to cover a trough of a housing; and
moving a conveyor member within the trough of the housing to move the product, carried by the conveyor member, from an input location of the trough at a bottom of the conveyor, through the trough, to an output location in the trough at a top of the conveyor with an inner surface of the cover reducing tumbling or rolling-over of the product due to: a curvature of the inner surface of the cover matching the curvature of an outer surface of the conveyor member; and to a gap, disposed between the outer surface of the conveyor member and the inner surface of the cover being smaller than the product.

27. The method of claim 26 wherein the moving the conveyor member within the trough comprises rotating a helical screw blade within the trough.

28. The method of claim 26 wherein the closing the cover to cover the trough comprises disposing all portions of the inner surface of the cover equidistant from the outer surface of the moveable conveyor member.

29. The method of claim 26 wherein the closing the cover to cover the trough comprises disposing the inner surface of the cover to be adjacent to the outer surface of the moveable conveyor member.

30. The method of claim 26 wherein the closing the cover to cover the trough comprises disposing the inner surface of the cover to be in a range of 1/32 inches to 2 inches away from the outer surface of the moveable conveyor member.

31. The method of claim 26 wherein the cover is semi-circular.

32. The method of claim 26 wherein the moving the conveyor member within the trough of the housing comprises rotating the moveable conveyor member around an axis so that the outer surface is farther away from the axis than any other surface of the moveable conveyor member.

33. The method of claim 26 wherein the closing the cover to cover the trough comprises rotating the cover relative to the housing at a pivot point so that the cover rotates from an open position uncovering the trough to the closed position.

34. The method of claim 33 wherein the closing the cover to cover the trough comprises rotating the cover relative to the housing with a hinge located at the pivot point.

35. (canceled)

36. (canceled)

37. (canceled)

38. (canceled)

39. (canceled)

40. (canceled)

41. (canceled)

42. (canceled)
